(19) United States
(12) Patent Application Publication
(10) Pub. No.: US 2008/0251750 A1
(43) Pub. Date: Oct. 16, 2008

(54) Valve for Fluids Containing Solid Particles or Liquid Drops

(76) Inventor: Yongsheng Song, Shanghai (CN)

Correspondence Address: GLOBAL IP SERVICES, 7285 W. Eagle Court, Winton, CA, 95388, US

(21) Appl. No.: 12/089,555

(22) PCT Filed: Oct. 8, 2005
(86) PCT No.: PCT/CN2005/001650

§ 371 Date: Apr. 8, 2008

(51) Int. Cl. F16K 5/00

(52) U.S. Cl. 251/315.1

(57) ABSTRACT

A valve assembly suitable to flowing through the fluid carrying solid particles or liquid drops. A closure element is provided for performing rotational or sliding linear operation in a body housing of the valve having inlet and outlet passageways therein. The initial stroke length of the present invention closure element from fully closed position to the position just permitting the fluid flow is lengthened so that a portion of its upstream surface engaged with the sealing surface of seat ring in fully closed position will not or less suffer the erosion of such erosive fluid during shut off or throttling.

### FIELD OF THE INVENTION

This invention relates to valves resistant to erosion for the fluid carrying solid particles or liquid drops, and more particularly to a closure element in the valves.

### BACKGROUND OF THE INVENTION

It is frequently needed to use a valve assembly to control flow of the fluid in the pipelines which incorporates the solid particles or liquid drops. Upstream surface of the closure element in a prior art valve will be damaged by impingement of such fluid for a short period of time during rotational or linear sliding motion between open and closed positions, so that the closure element loses the sealing capability engaged with upstream seat ring after the valve is closed and the valve begins to leak. And then they will still attack leaking paths formed on the upstream sealing surface of the closure element much stronger in fully closed position and cause them into heavy leaking openings rapidly, the valve has to be removed from the pipelines.

Valve manufacturers have being devoted themselves to improving surface hardness of the closure element made of metallic materials or employed the closure element made of or coated with high hardness ceramics in the prior art valve, in order to enhance its capacity of erosion resistant. It is effective only that hardened surface hardness of the metallic closure element is higher than the hardness of the solid particles, or disadvantage of micro fracture characteristic occurred easily in the ceramics has to be overcome after they are impacted by the solid particles or liquid drops carried in the fluid. The means improving surface hardness of the closure element will greatly increase material cost, expense of hardening process and processing charge machining hardened surface, and is neither a sole nor an universal choice solving erosion resistant.

The magnitude of the impact angles included between the particle flow directions in the fluid and the eroded surface of the different places on surface of the valve closure element, is various during a valve opening or closing operation, and different kinds of materials have their own impact angles at which it is high resistance to erosion, so that it is rather difficult to find out a material for the closure element which can resist the erosion at various impact angles simultaneously.

Additionally, the erosion loss of material is affected by shape, size, hardness and brittleness of the solid particles, as well as velocity and concentration of the particle flow. The solid particle erosion impinged on the surface of materials can be avoided only that the particles are flowing at a very slow velocity, but this way would not be adopted generally, because it will decrease the fluid conveying efficiency.

### BRIEF DESCRIPTION OF THE DRAWINGS

FIG. 1 is a longitudinal elevation sectional view of a prior art ball valve in fully open position.

FIG. 2 is simplified top view of the prior art ball valve in FIG. 1, only showing upstream and downstream seat rings, and a ball closure element in fully closed position.

FIG. 3 is a fragmentary top view similar to FIG. 2, and shows an example of the upstream surface of partly opened ball closure element being eroded by the abrasive fluid.

FIG. 4 is an embodiment of the present invention, only showing simplified fragmentary top view of the relationship between the ball closure element and seat rings in fully closed position.

FIG. 5 is a longitudinal elevation sectional view of a prior art gate valve in fully closed position.

FIG. 6 is a simplified fragmentary side view of FIG. 5, only showing the relationship among a gate closure element, a seat ring and a stem of the gate valve in fully closed position.

FIG. 7 is another embodiment of the present invention, only showing simplified fragmentary side view of the gate valve with the gate closure element, a seat ring and a stem in fully closed position.

### DESCRIPTION OF THE PREFERRED EMBODIMENTS

Surfaces of the ball closure element both in V-port ball valve and in semi-spherical ball valve have a regular curvature, because they are a segmental spheroid with a V-notch flowway or one portion of an entire spheroid respectively, and additionally, the closure element of a plug valve is a truncated cone or a cylinder and its surface also has a regular curvature. Although all of the closure elements are not an entire spheroid and have not a cylindrical flowway there through, they have a similar sealing principle and configuration to the ball valve, and rotate about an axis of their stems between fully open and fully closed positions; therefore the ball valve will be taken as representative of them.

The ball valve and gate valve are described and cited in their illustrations respectively hereinafter.

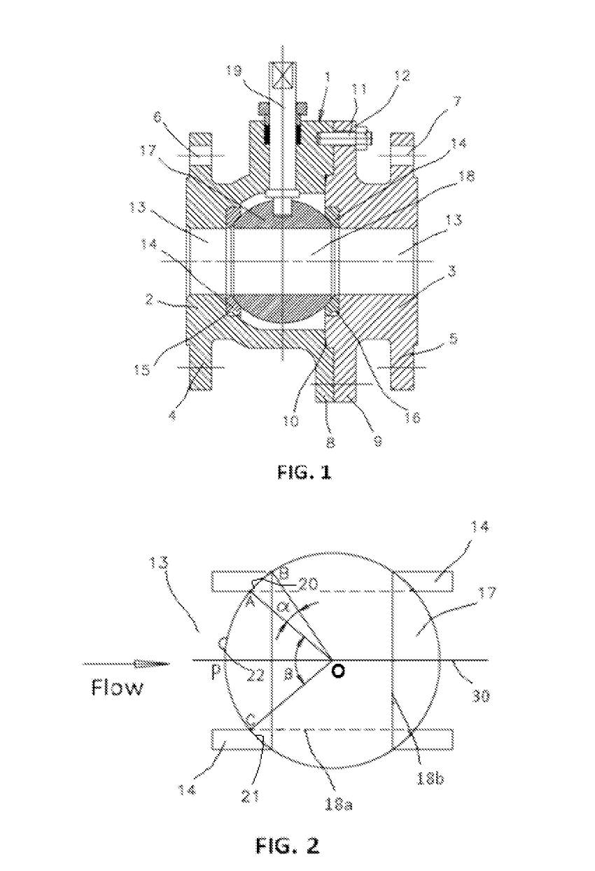

FIG. 1 is a cross-section in elevation view of a ball valve constructed in accordance with the prior art, which consists of a valve housing 1, a ball closure element 17, a stem 19 and two seat rings 14. The valve housing 1 is formed by the interconnection of a left-hand housing section 2 and a right-hand housing section 3 equipped with flanges 4 and 5 on its external ends respectively, used to be connected with pipelines by plurality of bolts and nuts (not shown) threading through holes 6 and 7 on them, and with other flanges 8 and 9 on its internal ends respectively, between which is disposed a gasket 10 used to effect a seal. One end of stud bolts 11 is screwed into tapped holes in flange 8 on the housing section 2, and the other end of them extended through registering holes in the flange 9 on the housing section 3. Nuts 12 are screwed onto the free ends of the stud bolts 11, make the flanges 8 and 9 join together. The gasket 10 will be compressed, and the flanges 8 and 9 meet together tightly when fastened together by the nuts 12, thereby two housing sections 2 and 3 form an unitary valve housing 1.

A pair of annular seat rings 14 are received within recesses 15 and 16 of the left-hand housing section 2 and the right-hand housing section 3 surrounding passageways 13 respectively, and are defined between the valve housing 1 and the ball closure element 17, and have the same inner diameter as the port of the passageways 13 of the housing sections 2 or 3 adjacent to it generally.

The ball closure element 17 is mounted between the two seat rings 14, and has a cylindrical flowway 18 extending there through which axis passes through the center of the ball closure element 17 and is normal to the axis of the stem 19. The flowway 18 of the ball closure element 17 is aligned with the passageways 13 of the housing sections 2 and 3, and permits the fluid to flow through smoothly when the valve 1 is in fully open position as shown in FIG. 1. The surface of the ball closure element 17 blocks the passageways 13 completely when the valve 1 is in fully closed position after the stem 19 turns the ball closure element 17 through 90° about its longitudinal axis, as shown in FIG. 2.

FIG. 2 is a simplified top view of the ball valve 1 in accordance with the prior art, showing the relationship between the seat rings 14 and the ball closure element 17 in fully closed position. The flowway position of the ball closure element 17 is plotted in full lines 18b, the flowway position in fully open position in dashed line 18a is imaginary. The points A and B are intersections intersected by the surface of the ball closure element 17 between the flowway 18b and 18a with the plane through the center ◯ of the ball closure element 17 and perpendicular to the axis of the stem 19 (not shown). The angle included between two radiuses linked the center ◯ of the ball closure element 17 and the points A and B respectively is an initial angle α of the ball closure element 17. The circular arc length 20 between the points A and B facing the angle a is an initial stroke length of it, and is also the narrowest length in the common surface between two passageways 18b and 18a, which is equal to the sealing surface radial width 21 of the seat ring 14. Magnitude of the diameter of a ball closure element is only related to the radial width of the sealing surface of the seat ring, namely its initial stroke length or to the initial angle facing it after determined the inner diameter of the flowway of the ball closure element (same as the passageways specified in the standards issued by various standard organizations in the world).

An imaginary annular spherical surface surrounding the flowway 18a plotted in dotted line, which inner diameter is the same as the upstream seat ring 14, the radial width is equal to the initial stroke length 20 and center of the circle is the point P intersected by the axis 30 of flowway 18a and the upstream surface 22 of the ball closure element 17 in fully closed position, could be constructed on the upstream surface 22 of the ball closure element 17. This annular spherical surface is the sealing surface of the ball closure element 17 engaged with the sealing surface 21 of the upstream seat ring 14 in fully closed position. The point B is located at periphery of the imaginary annular spherical surface.

A lot of tests demonstrated that the needed radial width of the sealing surface of a seat ring depends on leakage classes of a valve, the maximum pressure differential across the valve when it is closed, fluid categories and nature, material of the sealing surface and the coefficients related to the material of the sealing surface. The annular spherical surface of the ball closure element and the sealing surface of the seat ring are a pair of matched sealing surfaces, so the radial width of the annular spherical surface has to be equal to, or just a bit longer than the one of the sealing surface of the seat ring after the radial width of the sealing surface of the seat ring has been determined according to the prior art mentioned above, in order to ensure that an effective sealing between the ball closure element and the seat ring can be achieved. That is to say, the initial stroke length of the ball closure element is the same as the radial width of the seat ring at least.

The initial stroke length of a ball closure element relates to its diameter closely, overlong initial stroke length will not only lengthen the diameter of a ball closure element unduly, and cause cost of production to be raised further, but also increase the actuated torque of the valve, therefore the valve manufacturers always select a diameter for a ball closure element having an initial stroke length just equal to the radial width of sealing surface of the seat ring in fact for meeting the sealing requirement of the valve in a prior art.

The points A and C are two intersections intersected by the flowway 18a, the upstream surface 22 of the ball closure element 17 and the plane through the center ◯ of the ball closure element 17 and normal to the axis of the stem 19 (not shown). The angle included between two radiuses linked such two points and the center ◯ of the ball closure element 17 respectively, is the flowway angle β of the ball closure element 17. The circular arc length between the points A and C facing the flowway angle β is a flowway stroke length of the ball closure element opposite to the inner port diameter of the passageways 13.

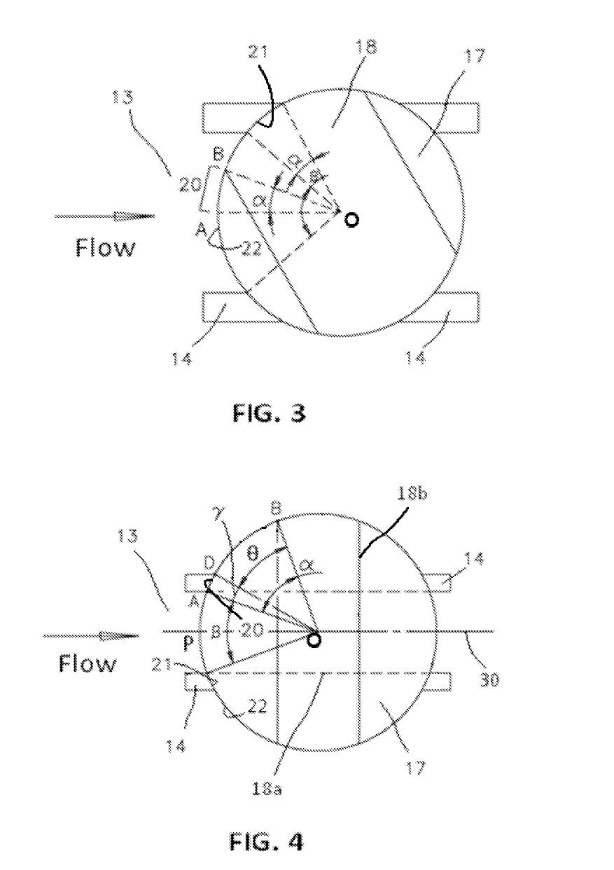

As shown in FIG.3, disengaged with the sealing surface of the seat ring 14, the point B on the periphery has entered into the passageway 13, and the flowway 18 of the ball closure element 17 starts to communicate with the passageways 13 in the housing sections 2 and 3 allowing the fluid to flow through valve opening after the ball closure element 17 has been turned through the initial angle a or the initial stroke length 20 from fully closed position actuated by the stem 19 counterclockwise. The diameter of the prior art ball closure element is calculated on the base of the radial width of the seat ring sealing surface, its initial stroke length is much shorter than the flowway stroke length.

The point B, which is in the position disengaged with the seat ring finally when opening the valve or the position blocking the passageway at last when closing the valve on the surface of the ball closure element, on the periphery of the annular spherical surface is beside the opening of the ball valve. The area around the point B is exposed to the fluid flowing in upstream passageway for the longest time and eroded at the highest velocity relatively during opening or closing operation. A velocity of the fluid flowing across the point A on the inside edge of the annular spherical surface is higher and time is longer too as it is near the point B for reasons of the narrow initial stroke length. On the other hand, a velocity flowing across the area away from the point B will be much lower, and the time also much shorter than the point B. Whenever the fluid carries the solid particles or liquid drops, the annular spherical surface around the point B will be eroded the most severely because of the highest velocity and the longest time. The damaged annular spherical surface keeps effective engaging with the sealing surface of the seat ring no longer and the valve becomes a much more severe leakage after staying in fully closed position for a short time.

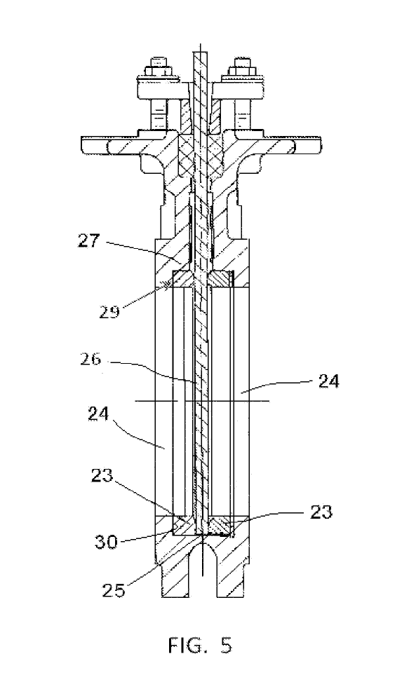

FIG. 4 is an embodiment of the present invention which only illustrates the relationship between the ball closure element 17 and the seat rings 14 in a ball valve. The diameter of the ball closure element 17 has been lengthened, therefore the initial stroke length between the points A and B has been become longer in comparison with the prior art ball valve. One portion of the initial angle a facing the lengthened initial stroke is an angle γ which faces the sealing surface radial width 21 of the seat ring 14, and the remainder of the lengthened initial angle a is a differential angle θ between the angles α and γ. Accordingly, the length of the lengthened initial stroke between the points A and B could be imaginarily divided in two portions. The interior annular spherical surface constructed by taking the point P intersected between the axis 30 of the passageway 13 and the upstream surface 22 in fully closed position as the center ◯ of the annulus, the inner 25 bore diameter of the seat ring 14 as its inner diameter and the circular arc length between the points A and D facing the angle γ as a radial width, is the sealing surface in the upstream surface 22 of the ball closure element engaged with the sealing surface 21 of the seat ring 14 when the valve is in fully closed position. The exterior annular spherical surface constructed by taking the circular arc length between the points D and B facing the angle θ as a radial width is nested outside the former concentrically, so the interior annular spherical surface is spaced out with the opening by the exterior annular spherical surface and away from the point B.

The point B enters into the passageway 13 and the fluid starts to flow through the valve after the ball closure element 17 is turned through the initial stroke length from fully closed position counterclockwise. Provided 1o that the angle θ is smaller than the angle β, some area of not only the exterior but the interior annular spherical surface is exposed to the fluid flowing in the upstream passageway 13, both of the annular spherical surfaces will be eroded severely whenever the fluid carries the solid particles or liquid drops. Differing from the prior art valve, the area around the point B eroded the easiest has not been on the outside edge of the interior annular spherical surface engaged with the sealing surface of seat ring 14 in fully closed position now, but on the periphery of the exterior annular spherical surface not engaged with the sealing surface of seat ring 14 in fully closed position, as a result, the exterior annular spherical surface bears the most severe erosion that should be borne by the interior annular spherical surface, and protects the interior one from much erosion, and it causes the eroded area, time and velocity for the interior annular spherical surface exposed to the fluid flowing in the upstream passageway 13 to be less and slower than the prior art ball valve. The bigger the θ is, the shorter the time is, the less the area is, the slower the velocity that the fluid flows across the area is, so the less the suffered erosion is. Provided that the angle θ is equal to or larger than the angle β, only some area on the exterior annular spherical surface exposed to the upstream passageway 13 will be eroded by the flowing fluid now, any area on the interior annular spherical surface relating to angle γ just leaves or has been moved out of the passageway 13 and would not be eroded. Consequentially the time, area and velocity eroded by the flowing fluid on the interior annular spherical surface depend on the length of the lengthened initial stroke mainly.

In reverse, when the ball closure element 17 starts to be turned from fully open position toward closed direction clockwise, and the area around the point B on the exterior annular spherical surface enters into the valve lo upstream passageway 13 firstly and is eroded by the flowing fluid immediately.

Provided that the angle θ is larger than or equal to the angle β, any area on the inner annular spherical surface has not entered into the passageway 13 yet or just wants to do it when the upstream surface 22 of the ball closure element 17 is rotated to the position where the point B touches the sealing surface 21 of the seat ring 14 and the flow starts to be blocked, so the erosion of the inner annular spherical surface would not take place. During the period of time to keep rotating the ball closure element 17 until it arrives in fully closed position, the inner annular spherical surface entered into the upstream passageway 13 would not be also eroded naturally because the fluid has been blocked by the exterior annular spherical surface and cannot flow.

Provided that the angle θ is smaller than the angle β, some area on the interior annular spherical surface also enters into the passageway 13 following the exterior annular spherical surface and is eroded by the flowing fluid before the point B touches the seat ring 14 and the passageway 13 has been blocked, but the position eroded firstly and severely is still the area around the point B on the exterior annular spherical surface, so that the interior annular spherical surface gets protected by the exterior annular spherical surface to some extent, and it causes the eroded time, area and velocity for the interior annular spherical surface exposed to the fluid flowing in the upstream passageway 13 to be less than the prior art ball valve, until the upstream passageway 13 is blocked by the upstream surface 22 of the ball closure element 17 completely. The factors affecting the extent of the erosion of the interior spherical surface are the same as the description of opening the valve above, and also depend on the magnitude of the angle θ lo or the initial stroke length.

The inner annular spherical surface entered into the passageway 13 would not be eroded yet even through the area around the point B on the exterior annular spherical surface has been damaged somewhat and cannot engage with the sealing surface of the seat ring perfectly after many times of opening and closing operation. The slight leakage between them only lasts a short period of time in which the damaged exterior annular spherical surface is brought into touch with the sealing surface of the seat ring 14, and the velocity of the fluid leaking across the leakage paths is slow, therefore it is not enough to constitute an erosive threat to any area on the interior spherical surface which has entered into the upstream passageway 13. The reason is that the velocity flowing across any area on the inner annular spherical surface should be much lower than the area around point B as it is at a distance from the damaged surface on the exterior annular spherical surface,

The position eroded the most severely on the upstream surface 22 of the ball closure element 17 is the area around point B on the periphery of the exterior annular spherical surface, and a degree of the erosion tapers off from the point B on the exterior annular spherical surface towards the interior annular spherical surface along the upstream surface 22 of the ball closure element 17. Therefore the longer the diameter of a ball closure element is, the longer its initial stroke length is, and the longer the circular arc length facing the angle θ in the initial stroke length is also, the better the interior annular spherical surface will get protected by the exterior annular spherical surface, and the ball closure element becomes much erosion resistant.

FIG. 5 is an elevation cross-sectional view of a prior art gate valve without guiding port (Gate valves with guiding port have the same principle) in fully closed position, which consists of a valve housing 27, a stem 28 (not shown), a gate closure element 26 and two annular seat rings 23, etc. The valve housing 27 includes two cylindrical passageways 24 in generally, and a chamber between the passageways 24 in which is disposed a gate closure element 26 for controlling flow of the fluid. The gate closure element 26 is reciprocated within the valve chamber by means of the valve stem 28 and a suitable operator mechanism, not shown. A pair of annular seat rings 23 is received within appropriate annular recesses 29 in the passageways 24 by two sides of the gate closure element 26 respectively.

A planar radial end face of the annular seat rings 23 establishes sliding engagement with the planar sealing surface of the gate closure element 26. The other rear radial end face is abutted on a shoulder 30 in the annular recesses 29. The valve housing 27 is provided with either wafer or flanges at each end thereof as traditional ways for connected to a pipeline.

A length at the bottom of the upstream surface of the gate closure element 26 from the end edge 25 along the axis of the stem 28 upwards, which is equal to the radial width of the sealing surface of the seat ring 23 normally, is an initial stroke length of the gate closure element 26. Another length being equal to the inner bore diameter of the seat ring 23 on the initial stroke length along the axis of the stem 28 upwards is a flowway stroke length of the gate closure element 26. A length of gate closure element 26 of the prior art gate valve along the axis of the stem 28 is equal to or a little longer than the sum of the radial width of the sealing surface of the seat ring 23 and the inner diameter of the seat ring 23, excluding the length for connecting the stem 28 with the gate closure element 26, after the inner diameter of the passageway 24 has been determined as the description of the ball valve in FIG. 2 above.

For the same reason as the ball valve described above, an overlong gate closure element can also increase a weight and production cost of the valve, thereby the length of a gate closure element of a prior art gate valve along the axis of a stem is exactly the sum of the radial width of the sealing surface and the inner diameter of the seat ring.

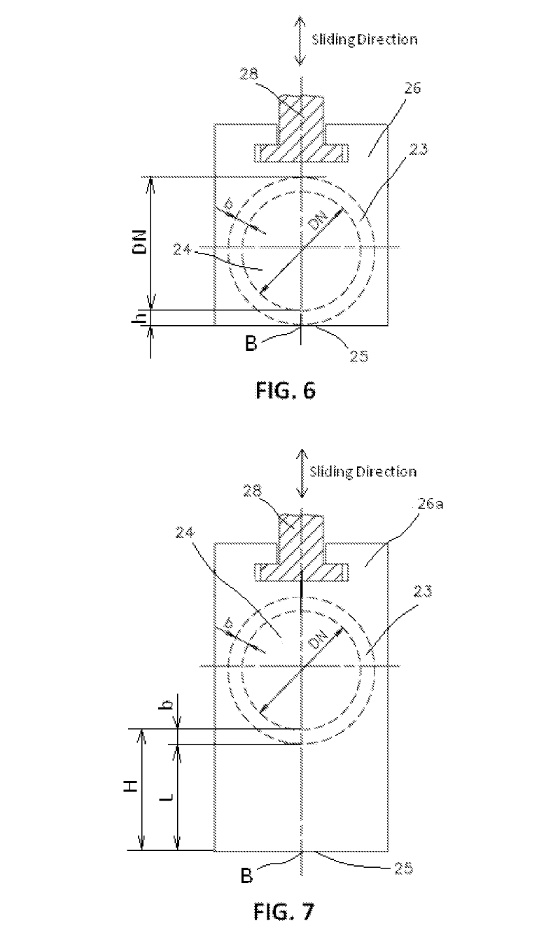

FIG. 6 is a simplified side cross-sectional view of a prior art gate valve without guiding port, which only illustrates a stem 28, a seat ring 23 and a gate closure element 26 in fully closed position. The diameter of the inner bore of the seat ring 23 surrounding a passageway 24 and disposed in an annular recess of a valve housing 27 (not shown) is the same one as the port of the passageways 24 adjacent to it generally. The gate closure element 26 has completely blocked the passageway 24. The length of the gate closure element has been designed to be as short as possible in the prior art gate valve as well, so that an initial stroke length h of a gate closure element is much shorter than a flowway stroke length DN of the gate valve. The fluid starts flowing through the valve after the middle point B of the end edge 25 of the gate closure element 26 has slid across an initial stroke length equal to the radial width b of the sealing surface of the seat ring 23 and enters into the passageway 24 surrounded by the seat ring 23 when the gate closure element 26 is pulled upwards by the stem 28, and all the upstream area of the gate closure element 26 exposed to the passageway 24 will be eroded by the flowing fluid to different extent until the middle point B has slid across the flowway stroke DN again and reached the fully open position at last, and in which the area around the middle point B of the end edge 25 will be eroded the longest and the most severely.

It has the same situation during closing the valve also. The area around the middle point B of the end edge 25 starts to be eroded by the flowing fluid as long as it enters into the passageway 24. The area exposed to the passageway 24 gets larger and larger with the valve being closed further, all of the area will be eroded, but the area around the middle point B will be eroded the longest and the velocity of the fluid flowing there through is the highest, so that it suffers the most severe erosion. The fluid stops flowing and the erosion ends after the middle point B of the end edge 25 has slid across the flowway stroke DN and touches the sealing surface of the seat ring 23. The valve arrives in fully closed position after the gate closure element 26 is pushed downwards further and has slid across an initial stroke h (being equal to the radial width b of sealing surface of the seat ring 23) again.

The upstream sealing surface around the middle point B of the end edge 25 of the gate closure element 26 has been severely eroded by the solid particles or the liquid drops incorporated in the fluid repeatedly after many cycles of operating the valve, and the length of its sealing surface engaged with the seat ring 23 has been shortened, the sealing capability between them fails in fully closed position, the valve starts leaking uninterruptedly. The solid particles or the liquid drops will attack and expand the leakage paths rapidly within a relatively short period of time when the gate closure element stays in fully closed position, and cause the valve to be damaged severely.

FIG. 7 is a simplified view of another embodiment of the present invention applied to gate valves without guiding port (Gate valves with guiding port have the same principle); it has the same principle as the ball valve described above. The initial stroke length H of the improved gate closure element 26a has been lengthened compared with the initial stroke length h of the prior art gate valve, and is still located at the bottom of its upstream sealing surface from the end edge 25 upwards along the axis of the stem 28. The rectangular area formed by taking the initial stroke length H as a width and the width of the gate closure element 26a as a length, could be divided into two imaginary upper and lower portions which boundary between them is normal to the axis of the stem 28, in which the surface of rectangular area of the lower portion close to the end edge 25 is used for bearing erosion during opening or closing operation, its width is expressed as a letter L; and the upper portion on it, which width of the rectangular area is b, is the area engaged with a part of the sealing surface of the seat ring 23 in fully closed position of the valve.

The longer the initial stroke length H of the gate closure element 26a is lengthened after determined the size of the valve, the wider the width of rectangular area of the lower portion is, the better the surface of the rectangular area of the upper portion engaged with the sealing surface of the seat ring in fully closed position will be protected, so that the gate closure element 26a can get longer life.

The middle point B of end edge 25 in lower portion of the lengthened gate closure element 26a starts to be disengaged with the sealing surface of the seat ring 23 and the fluid flows through the passageway 24, as long as that it enters into the passageway 24 during opening the valve (lifting the stem 28 upwards). The upper and lower portions are both eroded by the fluid, provided that the width L of the rectangular area of the lower portion is shorter than the flowway stroke DN of the valve (being equal to the inner bore diameter of the seat ring 23) during operating the valve, but the lower portion shall be eroded more severely than the upper portion because it is near the point B, so the upper portion can be protected by the lower portion in part. The upper portion is protected by the lower portion completely and will not be eroded by the fluid at all, provided that the width L of the rectangular area of the lower portion is equal or longer than the flowway stroke length DN. The reason is that any area of the upper portion has left or just wants to leave the passageway 24 when the middle point B of end edge 25 enters into the passageway 24.

The principle of closing operation related to the gate closure element of the present invention will not be described, since it is the reverse of the opening valve described above and similar to the description for the ball valve too.

Although the present invention was described in terms of specific embodiments, it is obvious to a person skilled in the art that various alterations and additions are possible without departing from the spirit of the invention which is set out in the appended claims, therefore the extent disclosed in the embodiments above is only for purpose of illustration and not intended to be limited by this description. The art of the present invention valve closure elements are also applicable to full bore ball valve, reduced bore ball valve, V-port ball valve, semi-spherical ball valve, floating ball valve, trunnion ball valve, plug valve, parallel-slide gate valve, knife gate valve and sliding gate valve, etc.

1. A valve for fluids containing solid particles or liquid drops comprising:
a body housing, said body housing having upstream and downstream passageways, and an interior chamber between said upstream and downstream passageways adapted to receive a valve closure element, an opening passing through said body housing and being normal to the axis of said passageways used for mounting a valve stem, an annular recess composed of a radial shoulder and an inner circumferential surface surrounding the upstream passageway for accommodating seat ring;
a stem, said stem having a lower end extending into said body housing through the opening of said body housing and connected with the top of said valve closure element, and an upper end exploded outside said body housing connecting with a device for actuating said valve closure element;
a circular seat ring, said seat ring positioned within said annular recess in the upstream passageway of said body housing, and rested on each side of said closure element, each said seat ring located between said body housing and said closure element, one radial end surface of said seat ring engaged slidably with said closure element being a plane or a curved surface with a radial width designed according to prior arts, other rare radial end surface abutting on the shoulder of the recess; said seat ring surrounding said passageway and having an inner bore sized and shaped the same as the adjacent port of said passageway, the radial width of said seat ring being the radial width of a sealing surface engaged with the upstream surface of said closure element;
a closure element, said closure element being received in the interior chamber between said upstream and downstream passageways and having a top connected with a lower end of said stem, said closure element being rotated or reciprocated about or along the axis of said stem with respect to said body housing for shutting off or throttling the fluid flow actuated by said stem;
initial stroke being a rotational or linear moving length of said closure element from a fully closed position to a just starting position for fluid flow during opening the valve, or from a just blocked position to fully closed position for fluid flow during closing the valve;
said initial stroke length of said closure element being equal to the radial width of the sealing surface of said seat ring;
wherein said initial stroke length of said closure element being lengthened by increasing the diameter of said closure element or the length of said closure element along the axis of said stem, thereby the lengthened initial stroke length of said closure element is longer than the radial width of the sealing surface of said seat ring, the life of the valve is increased.

2. The valve of claim 1, wherein the lengthened initial stroke length of said closure element is equal to or longer than a sum of the radial width of the sealing surface of said seat ring plus the inner bore diameter of said seat ring.

3. The valve of claim 1, wherein the sealing surface of said closure element is an annular spherical surface as said closure element is a ball closure element having spherical shape of ball valves, increasing the diameter of said ball closure element is equivalent to lengthen the length of said initial stroke, said lengthened initial stroke length is longer than the radial width of the sealing surface of said seat ring, an annular spherical surface formed on the upstream surface of said ball closure element, for the annular spherical surface its center is located at the point intersected between the axis of the upstream passageway and the upstream surface of said ball closure element in fully closed position, its inner diameter is the same as the bore of said seat ring and its radial width is equal to said lengthened initial stroke length, the annular spherical surface could be divided into two annular spherical surfaces nested concentrically, in which the radial width of the interior annular spherical surface is equal to the radial width of the sealing surface of said seat ring, and the remainder in said lengthened initial stroke is the radial width of the exterior annular spherical surface.

4. The valve of claim 3, wherein the lengthened initial stroke length of said ball closure element is equal to or longer than a sum of the radial width of the sealing surface of said seat ring plus the inner bore diameter of said seat ring, in which the radial width of said interior annular spherical surface is equal to the radial width of the sealing surface of said seat ring, the radial width of said exterior annular spherical surface is equal to or longer than the inner bore diameter of said seat ring.

5. The valve of claim 1, wherein said closure element is a plug closure element of plug valves, the sealing surface of said closure element is an annular cylindrical or conical surface having a plug closure element with a cylinder or truncated cone, increasing the diameter of said plug closure element being equivalent to lengthening the length of said initial stroke, said lengthened initial stroke length being longer than the radial width of the sealing surface of said seat ring, for the annular cylindrical or conical surface formed on the upstream surface of said plug closure element its center is located at the point intersected between the axis of the upstream passageway and the upstream surface of said plug closure element in fully closed position, its inner diameter is the same as the bore of said seat ring and its radial width is equal to said lengthened initial stroke length, the annular cylindrical or conical surface could be divided into two annular cylindrical or conical surfaces nested concentrically, in which the radial width of the interior annular surface is equal to the radial width of the sealing surface of said seat ring, and the remainder in said lengthened initial stroke is the radial width of the exterior annular surface.

6. The valve of claim 5, wherein the lengthened initial stroke length of said plug closure element is equal to or longer than a sum of the radial width of the sealing surface of said seat ring plus the inner bore diameter of said seat ring, in which the radial width of said interior annular surface is equal to the radial width of the sealing surface of said seat ring, the radial width of said exterior annular surface is equal to or longer than the inner bore diameter of said seat ring.

7. The valve of claim 1, wherein said closure element is a gate closure element of gate valves, the sealing surface of said closure element is a plane surface, the gate closure element is a rectangular slab, increasing the length of the gate closure element along the axis of the stem upwards is equivalent to lengthen the length of said initial stroke, said lengthened initial stroke length being longer than the radial width of the sealing surface of said seat ring, for the rectangular area formed at the bottom of the upstream surface of said gate closure element from the end edge upwards along the axis of said stem, it takes said lengthened initial stroke as a width parallel to the axis of said stem and the width of said gate closure element as a length, it could be divided into two adjacent upper and lower portions, which boundary is normal to the axis of said stem, in which the width of the upper rectangular area closer to said stem is equal to the radial width of the sealing surface of said seat ring, and the width of the lower rectangular area under the upper rectangular area is the length remained in said lengthened initial stroke.

8. The valve of claim 7, wherein said lengthened initial stroke length of said gate closure element is equal to or longer than a sum of the radial width of the sealing surface of said seat ring plus the inner bore diameter of said seat ring, the width of said upper rectangular area is equal to the radial width of the sealing surface of said seat ring, the width of said lower rectangular area is equal to or longer than the inner bore diameter of said seat ring.

9. The valve of claim 1, Wherein said closure element is a segmental ball closure element of semi-spherical valves or V-port ball valves, the sealing surface of said closure element is an annular spherical surface, the segmental ball closure element is one portion of an spheroid or a segmental spheroid with a V-notch flow way, increasing the diameter of said segmental ball closure element is equivalent to lengthening the length of said initial stroke, said lengthened initial stroke length being longer the radial width of the sealing surface of said seat ring, for said annular spherical surface formed on the upstream surface of said segmental ball closure element, its center is located at the point intersected between the axis of the upstream passageway of said valve housing and the upstream surface of said segmental ball closure element in fully closed position, its inner diameter is the same as the bore of said seat ring and its radial width is equal to said lengthened initial stroke length, it could be divided into two annular spherical surfaces nested concentrically, in which the radial width of the interior annular surface is equal to the radial width of the sealing surface of said seat ring and the remainder in said lengthened initial stroke is the radial width of the exterior annular surface.

10. The valve of claim 9, wherein said lengthened initial stroke length of said segmental ball closure element is equal to or longer than a sum of the radial width of the sealing surface of said seat ring plus the inner bore diameter of said seat ring, in which the radial width of said interior annular surface is equal to the radial width of the sealing surface of said seat ring, the radial width of said exterior annular surface is equal to or longer than the inner bore diameter of said seat ring.
